(19) United States
(12) Patent Application Publication
(10) Pub. No.: US 2012/0222345 A1
(43) Pub. Date: Sep. 6, 2012

(54) FISH-ON DEVICE

(76) Inventor: LUIS G. SANCHEZ, Surprise, AZ (US)

(21) Appl. No.: 13/412,608

(22) Filed: Mar. 5, 2012

Related U.S. Application Data
(60) Provisional application No. 61/448,995, filed on Mar. 3, 2011.

(51) Int. Cl. A01K 97/12

(52) U.S. Cl. 43/17

(57) ABSTRACT

A new fish-on line indicator has a counterweight sufficiently heavy to hold a fishing line taut and sufficiently visible to alert the angler that the fishing has moved; a swivel to slip over the fishing line to position the counterweight for view of the action; and a connector for connecting the counterweight to the swivel, the connector comprising a sufficiently heavy and water resistant material. A screw eye can be substituted with a rod going through the counterweight and secured at one end with a plate and the other end connecting directly to the swivel.

### TECHNICAL FIELD

The present invention relates generally to the field of fishing floats and more specifically to indicators of a fish on a fishing line.

### BACKGROUND

A float is a device used by anglers to accomplish various purposes when fishing. As they are designed to float on the water surface, floats are used to indicate when a fish is biting at the bait on a hook. As well as indicating a bite, a float also alerts other anglers to the location of a fishing line to prevent the tangling of lines. In addition to indicating means, floats provide for the suspension of bait at a desired depth in the water Some floats even provide the angler a means by which to guide the fishing line into hard-to-reach places such as under docks or trees. Produced in various shapes and sizes, floats are useful in multiple situations, including still and even slow-moving waters. While useful in their own right, traditional floats leave room for improvement in creating line tension to secure a fish on the hook. Slack allowed in fishing lines from traditional floats may allow fish to consume bait from a hook without being snared by the hook.

Key skills in successful still-fishing (angling with stationary hooked bait weighted down with a sinker) are being able to instantly detect a strike and quickly set the hook. Detecting a strike and setting the hook require that the angler maintain a taut line with no slack. This generally requires the angler to hold the rod for long periods of time, winding a turn or two on the reel to take up the slack and keeping one fingertip against the line in order to feel a fish strike. Fishing in this manner throughout an entire day can become tiresome.

Various attempts have been made to solve problems found in float art. Among these are the following: U.S. Pat. No. 4,845,884 to Thomas G. Pacitti; U.S. Pat. No. 7,454,863 to Bobbie D. Holsey; and U.S. Publication No. 2008/0040966 to Gary D. Stone et al.

### SUMMARY OF THE INVENTION

In one embodiment, a fish-on line indicator has a counterweight, a swivel and a connector for the swivel and counterweight. The counterweight is sufficiently heavy to hold a fishing line taut and sufficiently visible to alert the angler that the fishing gear has moved. The swivel slips over the fishing line to position the counterweight for view of the action, and the connector connects the counterweight to the swivel, the connector comprising a sufficiently heavy and water resistant material. Optionally, the connector is a screw eye having an eye diameter of about ⅛ inch to about one inch, or more preferably about 5/16 inch. The screw eye is made of stainless steel or brass. The swivel is about 1-¼ to about 3 inches long, and more preferably 2-½ inches. In a preferred embodiment, the swivel is made of brass. The counterweight material is UV and water resistant material. The weight of the fish-on indicator is about 1 to 4 ounces which helps hook the fish.

### BRIEF DESCRIPTION OF THE DRAWINGS

For a further understanding of the objects and advantages of the present invention, reference should be had to the following detailed description, taken in conjunction with the accompanying drawing, in which like parts are given like reference numbers and wherein:

FIG. 1 shows an exemplary fish-on device on a fishing line.

FIG. 2 shows a perspective view illustrating a fish-on indicator as used by an individual according to an embodiment of the present invention.

### DETAILED DESCRIPTION OF THE PREFERRED EMBODIMENTS

I have fished for years yet never found a suitable fish-on device. I have seen many improvised devices that quickly fall off or fall apart. None of the above publications and patents I have seen appear to describe the invention. Thus, I set to work on solving the problem of providing a reliable fish-on indicator to provide the tautness and visual indication means of a fish on an angler's line and to avoid the above mentioned problems.

My fish-on device solves the problem of providing the angler with a reliable fish-on indicator that visually indicates the presence of a fish nibble so that the fisher need not spend the entire day with holding the line taut. Thus, the angler can engage multiple lines or fish hands free. Because my fish-on device is made from strong materials (see the below), it does not contribute to the loss and disablement of fish with hooks and lines caught in their mouths. Moreover, because my fish-on device is not easily lost, it does not contribute to the littering and pollution of fishing gear on the bottom of fishable waters, thus contributing to a better environment.

I have surprisingly found that that my device also helps hook the nibbling fish, thus avoiding the frequent loss of fishes when the angler does not immediately tug on the line to set the hook. Not only are injured fishes lost to the fisherman, but these fish are weakened and may soon die, thus depleting the fish supply.

My fish-on device accomplishes these important tasks: first, the fish-on device keeps the fishing line taut and serves as a highly visible strike indicator; second the fish-on device serves as a resistant counterweight and prompts the striking fish to hook itself; and third, the fish-on device allows the angler to set down the fishing rod to fish hands-free until a fish is hooked and ready for the fight. “Fish on” is a phrase with which most anglers are familiar; it is often what is called out when other anglers are nearby and a fish has been hooked. Hearing the shout of “fish on,” other anglers immediately see which line has a fish and give the successful angler room to maneuver. Frequently other anglers reel in their lines to avoid tangling their lines with that of the successful angler. The fish-on device is a simple and effective piece for tackle that helps hook the fish and also alerts the angler to the fish strike.

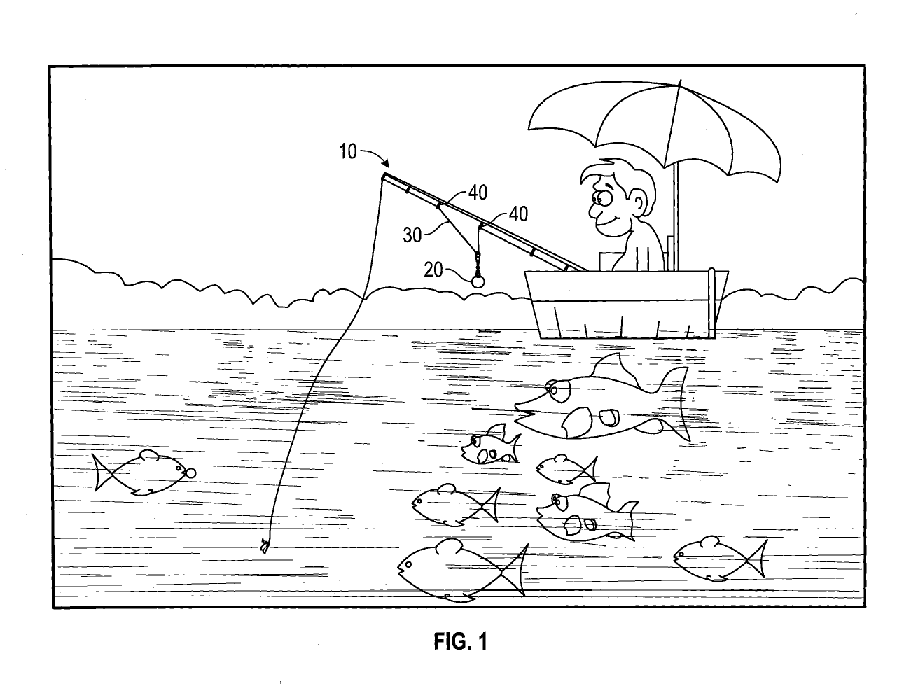

FIG. 1 shows one example of a fishing rod 10 with the fish-on device 20 installed on the fishing line 30 in one of the preferred locations between the rod guides 40. The fish-on device 20 is shown clipped onto the fishing line 30 where it helps maintain a taut line, provides automatic resistance to a striking fish and provides the angler with a visual cue of “fish on”.

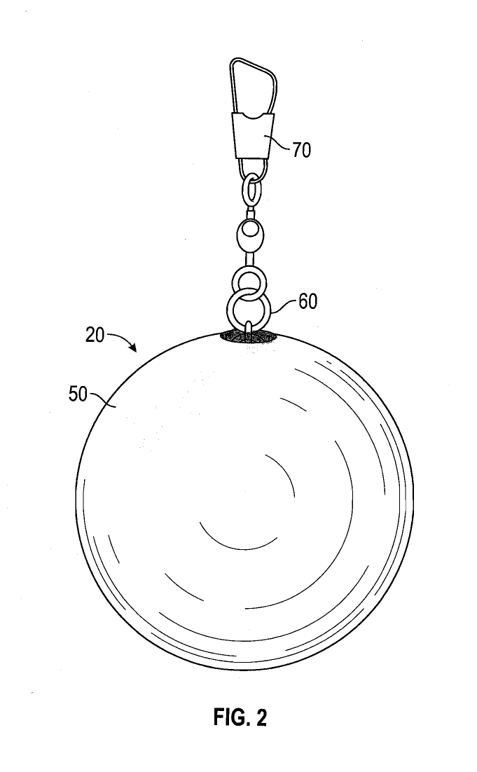

FIG. 2 shows a preferred embodiment, in which the fish-on device 20 has a counterweight 50, equipped with a connector such as a screw-eye 60 and a latched piece, such as a brass barrel-type swivel 70.

In one embodiment, the fish-on counterweight is round with a diameter of about 1-¾inches. The diameter can be about one to three inches, or preferably between 1-¼ inches and about 2-½ inches. The counterweight need not be round but can be any desired shape, such as a team mascot. The counterweight can be covered with any of a variety of designs. In any form, the counterweight is strikingly visible, for example, neon yellow or orange, so that it shows up day or night. For night fishermen, the fish-on can be supplied with and weighted by a light, either external to the counterweight or as an integral part of the counterweight. When equipped with a light, the counterweight has a waterproof door for batteries and replacing the light. In my preferred embodiment, the device has a weight of about 1.8 ounces. However, that can be varied from about 1 ounce to about 4 ounces. Heavier weights are preferred for poles that are set up and not immediately manned because the heavier weights are better at setting the hook. The counterweight is preferably made of a water and UV resistant material, such as plastic, neoprene or treated rubber.

To attach the fish-on device to the line, and my preferred part is a swivel, more preferably, a 2-½ inch standard barrel. This swivel can be about 1-¼ inch to 3-½ inches long. The swivel width is preferably about 7/16 wide, but it can be about ¼ inch to about 1 inch wide. This too is made of a UV and water resistant material that is also strong enough to not fall off and pollute the body of water. My preferred material is brass or steel.

Connecting the counterweight to the swivel is a screw-eye that is screwed into the counterweight and is preferably made of either stainless steel or brass. Any way of connecting the swivel and the counterweight can be used, including using a one-piece swivel-screw head. I used separate screw eye and swivel for convenience, but that is not integral to the invention. In this embodiment, I used a 5/16 inch screw eye, but a suitable range of dimensions is ½ inch to 1 inch.

Realizing that the screw eye can come loose from the rubber or plastic counterweight, I made an additional modification in which the screw eye is replaced with a rod going through the center of the counterweight. The rod at one end is secured with a plate and the other end is attachable to the swivel. The swivel can be attached directly to one end of the rod, thus avoiding the use of the screw eye for intermediate connection to the swivel.

Simple in design and construction, the fish-on device is easy to assemble. One obtains a strong swivel and uses it to connect to a screw-eye whose screw is imbedded in the counterweight. Additional wire can be used to connect the swivel and screw eye.

The fish-on device also is easy to use and is highly effective. When still-fishing with bait, an angler must keep the fishing line taut, else the fish merely strikes the bait and swims off with it. This tautness is necessary in order to sense a strike through the line and to set the hook into the fish's mouth by sharply moving the rod tip. The fish-on device automatically accomplishes both tasks. Once the line is cast and made taut by reeling in the slack, the angler opens the clasp of the fish-on swivel and slips the device onto the line above the first rod guide. The rod is then set into a rod holding apparatus or is leaned against the rail of a dock, boat or pier. The fish-on device pulls the line taut, and when a fish moves the bait, the motion is transmitted up the line, making the fish-on device bob in response. Since the fish-on device has sufficient mass to act as the counterweight, counterweight exerts pressure on the line that results in the fish hooking itself rather than simply removing the bait.

Although specific embodiments have been illustrated and described herein, those of ordinary skill in the art will appreciate that any arrangement calculated to achieve same purposes can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

In the foregoing description, if various features are grouped together in a single embodiment for the purpose of streamlining the disclosure, this method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims, and such other claims as may later be added, are hereby incorporated into the description of the embodiments of the invention, with each claim standing on its own as a separate preferred embodiment.

1. A fish-on line indicator comprising
a counterweight sufficiently heavy to hold a fishing line taut and sufficiently visible to alert the angler that the fishing has moved;
a swivel to slip over the fishing line to position the counterweight for view of the action;
a connector for connecting the counterweight to the swivel, the connector comprising a sufficiently heavy and water resistant material.

2. The fish-on indicator of claim 1 wherein the connector is a screw eye.

3. The fish-on indicator of claim 2 wherein the connector has an eye of about ⅛ inch to about one inch.

4. The fish-on indicator of claim 2 wherein the screw eye has an eye of about 5/16 inch in diameter.

5. The fish-on indicator of claim 2 wherein the screw eye is made of steel or brass.

6. The fish-on indicator of claim 1 wherein the connector is a rod that goes through the counterweight and fastened with a plate at one end and directly connected to the swivel at the other end.

7. The fish-on indicator of claim 1 wherein the swivel is about 2-½ inch long.

8. The fish-on indicator of claim 7 wherein the swivel is about 1-¼ to about 3 inches long.

9. The fish-on indicator of claim 7 wherein the swivel is made of brass.

10. The fish-on indicator of claim 1 wherein the counterweight comprises UV and water resistant material.

11. The fish-on indicator of claim 10 wherein the counterweight is round and connected to the swivel with a screw eye.

12. The fish-on indicator of claim 11 wherein a rod passes through the counterweight and is fixed at one end with a plate and at the other end directly to the swivel.

13. The fish-on indicator of claim 1 wherein the weight of the fish-on indicator is about 1 to 4 ounces.
